(19) United States
(12) Patent Application Publication
(10) Pub. No.: US 2018/0351503 A1
(43) Pub. Date: Dec. 6, 2018

(54) Solar Power Generation System

(71) Applicant: Huseyin Ozcan, Houston, TX (US)

(72) Inventor: Huseyin Ozcan, Houston, TX (US)

(21) Appl. No.: 15/613,132

(22) Filed: Jun. 2, 2017

Related U.S. Application Data
(60) Provisional application No. 62/392,437.

(51) Int. Cl. H02S 40/20; H02S 40/32

(52) U.S. Cl. CPC H02S 40/20; H02S 40/32

(57) ABSTRACT

The present invention provides the capability of the design of modular solar energy plants by using compacted arrangement of solar panels which are internally energized by artificial and/or sun light as well as other alternative wave energy sources, such as alpha, beta and gamma rays.

### NON-PROVISIONAL PATENT APPLICATION

This application claims the benefit of provisional application 62/392,437

### BACKGROUND

This invention relates to a device and method of generating electricity using solar panels. More specifically a device and method utilizing a compacted arrangement of solar panels.

Solar panels are widely used to generate electricity. The panels face to the sun benefit from sunlight. When there is no sunlight no energy is produced.

The current industry practice is to install the panels in an open field which requires large areas or on roof tops where there is not enough space to install more solar panels and generate sufficient electricity for home usage. Installing solar panels on roof tops is an eyesore and restricted in many communities in spite of the federal law approval. The roof top installation is labor intensive and the cost is higher compared to what is proposed in this patent application.

The present invention provides a new arrangement of solar panels wherein a power plant can be assembled and packaged in a shop environment and relocated to the back yard of a house or a field just like an air conditioning or electric power generator or transformer unit.

### SUMMARY

One of the major objectives of the present invention is to provide a face to face arrangement of single and double sided solar panels to save space.

Another objective of the present invention is to use of artificial LED light to energize and generate power from solar panels.

Another objective of the present invention is to use of acrylic or polymers type light diffusing panels to illuminate solar panels to energize and generate power.

Another objective of the present invention is to Use of mirrors to reflect external light onto the solar panels as arranged in the first item above.

Another objective of the present invention is to Construction of double sided solar panels for power generation to improve space efficiency and power output on per solar panel basis.

Another objective of the present invention is to use of radioactive materials and rays to generate power.

Another objective of the present invention is to use tubular mirrors and acrylic rods to distribute a single light source

Another objective of the present invention is to use various locations to energize solar panels and provide lighting.

Another objective of the present invention is to use of LED, LCD and PLASMA screens to energize solar panels.

Another objective of the present invention is to use and manufacturing acrylic or fiber optic panels to energize solar panels.

The present invention provides the capability of the design of modular solar energy plants by using compacted arrangement of solar panels which are internally energized by artificial and/or sun light as well as other alternative wave energy sources, such as alpha, beta and gamma rays. Further objects and advantages of the invention will become apparent from a consideration from the drawings and ensuing descriptions.

### BRIEF DESCRIPTION OF THE DRAWINGS

FIG. 1A illustrates a front view of an acrylic light diffuser panel

FIG. 1B is an illustration of one embodiment of the solar system utilizing the acrylic light diffuser panel in FIG. 1A.

FIG. 2A is a top view of an illustration of another embodiment of the solar system utilizing solar panels with embedded LEDS and reflective mirrors.

FIG. 2B is side view of an illustration of another embodiment of the solar system utilizing solar panels with embedded LEDS and reflective mirrors.

FIG. 2C illustrate a front view of the solar panels with embedded LEDS.

FIGS. 3A and 3C illustrate the construction of solar cells of single sided panel.

FIGS. 3B and 3D illustrate the construction of solar cells of double sided panel.

FIGS. 4A and 4B are an illustration of one embodiment of the solar system utilizing the LED, LCD and Plasma.

FIGS. 5A, 5C and 5E illustrate the tubular transparent mediums used to connect to the light sources.

FIGS. 6A and 6B is an illustration of one embodiment of the solar system utilizing fiber optic panels.

FIG. 7 is an illustration of one embodiment of the solar system utilizing radioactive material.

### DETAILED SPECIFICATIONS

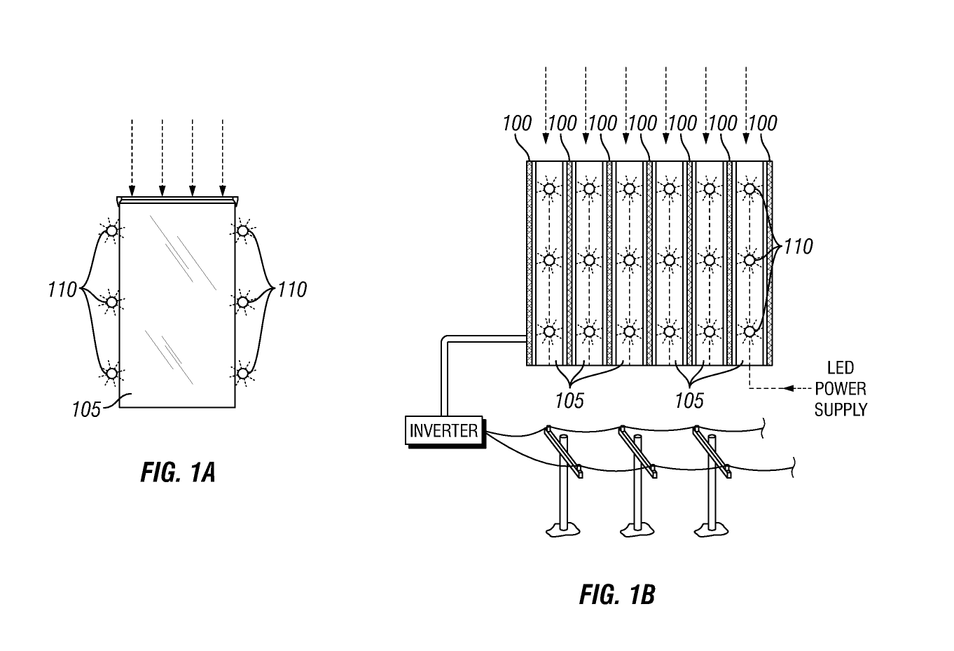

Referring to FIG. 1-7, there is shown alternative embodiments of the present invention that provides a solar system for generating electricity utilizing an array of stack solar panels. As shown in each embodiment in the referenced drawings, a plurality of spaced apart solar panels are arranged stacked looking face to face in a stacked parallel arrangement as shown in each of the embodiments in FIGS. 1-7. The stack array of solar panels can be arranged horizontally or vertically.

A photovoltaic cell (PV cell) is a specialized semiconductor diode that converts visible light into direct current (DC). Some PV cells can also convert infrared (IR) or ultraviolet (UV) radiation into DC electricity. Photovoltaic cells are an integral part of solar-electric energy systems, which are becoming increasingly important as alternative sources of utility power.

With today technology large sets of PV cells are interconnected together to form solar panels used in the present invention. The use of PV cells and batteries for the generation of usable electrical energy is known as photovoltaics. The number of required solar panels are pre-determined by power requirements of the specified area. The solar cells generate DC current electricity that is transmitted to an inverter that converts the DC electric current to an AC electric current that is placed on a power grid.

The stacked arrangement of the solar panels requires less space than the general arrangement used today. The present invention system can run continuously without sunlight by using artificial light sources, such as low powered bright LED lights. The LED lights can be powered by a separate solar panel during the daytime or by a charged battery and/or an external electric power source during the night time.

The solar panels in this system do not need to face to the sunlight, but external sunlight can be carried into the unit through a transparent light transmission medium system and diffused to the face of the solar panels to energize and generate power. The transparent transmission medium can be a mirror, fiber optic cables, acrylic and glass plates and rods or their combination.

The whole unit can be packaged as a closed system to be protected from environmental hazards. The closed system will not require any protective glass over the solar cells thus minimizing light loses due to reflectance. The transmission of light to the face of solar panels can be done in two ways.

Referring to FIGS. 1A and 1B, there is shown an embodiment of the present invention using an acrylic light diffuser plate (105) gridded with LEDS (110). The gridded acrylic plate (105) can diffuse the sunlight supplied from top and side edges of the plate as shown in FIGS. 1a and 1b. At night, a battery can provide power supply to the LEDS (110). As shown, an acrylic plate (105) are sandwiched between the inward facing stacked solar panels (100).

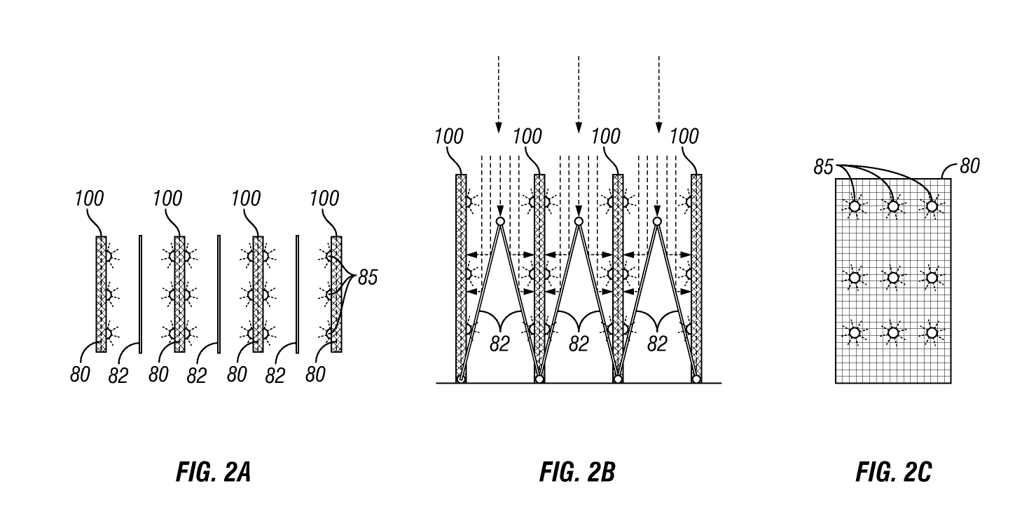

Referring to FIGS. 2a-c, there is shown an alternative embodiment of the present invention using reflective mirrors. In this embodiment, a film or glass mirror (82) set up is used to reflect the light to the solar panels (80) as shown in FIG. 2b. Sunlight can be supplied from the top edge (100) and LEDs (85) embedded on solar panels (80). The mirrors (82) reflect light to energize solar panels (80).

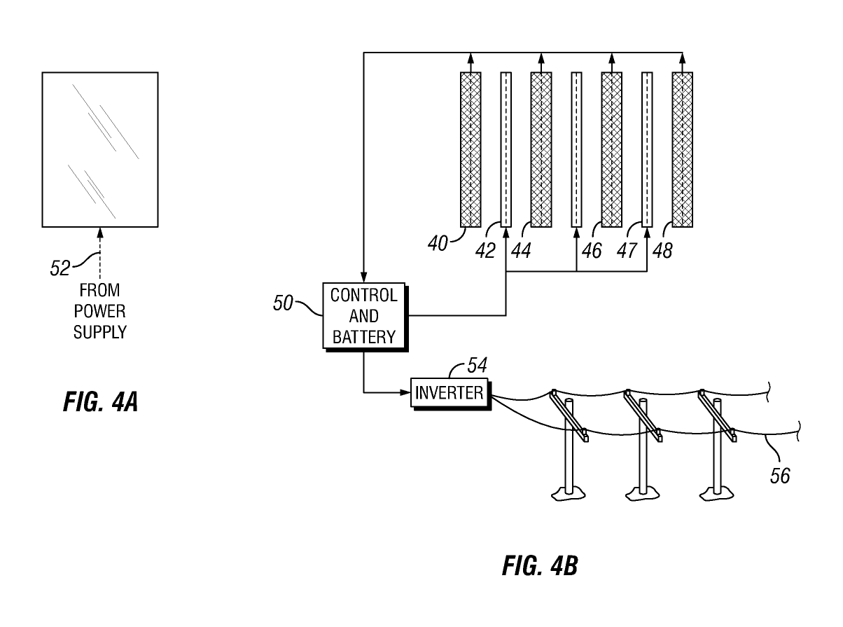

Referring to FIGS. 4a and b, there is shown an embodiment of the present invention utilizing screen technologies. Currently marketed flat screen televisions utilizes LED, LCD and PLASMA screen technology. These screens can be adapted and used as artificial light sources to energize solar panels as depicted in FIG. 4. In the present invention, these screens can be manufactured to function as single or double sided screens. In this embodiment the screens are used as an alternative diffuser light medium that is situated between each stacked solar panel.

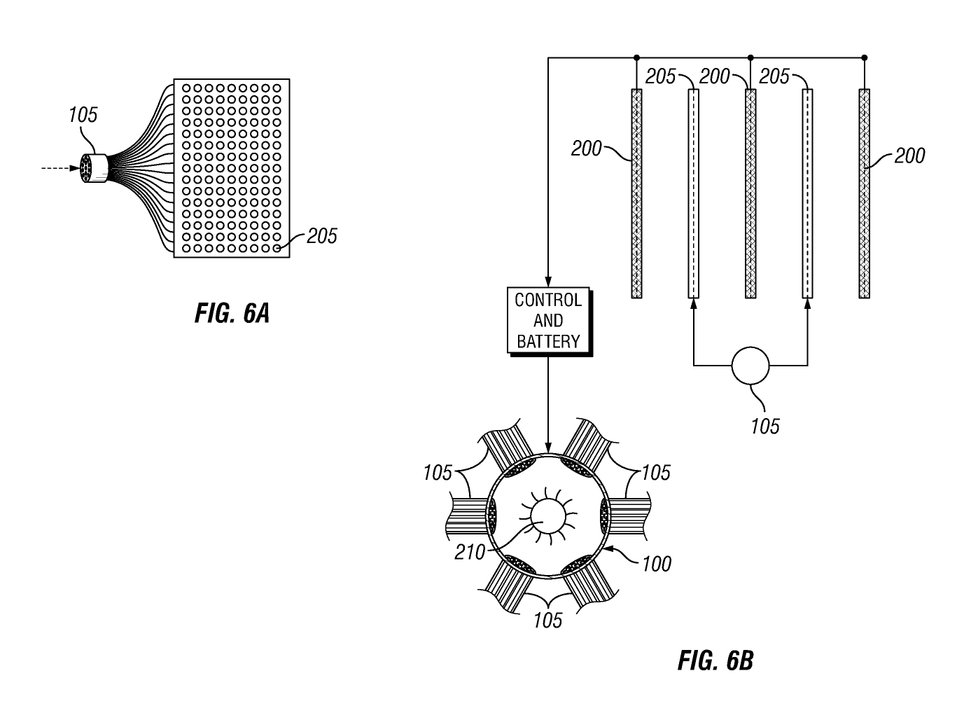

Referring to FIGS. 6B and B, there is shown an embodiment of the present invention utilizing fiber optic technology. In this embodiment, fiber optic panels (200) can be manufactured as shown in FIG. 6A wherein a perforated metal or plastic plate is injected with fiber optic or acrylic liquid from one face to form a bundle of fiber cables on the other side of the plate under strict temperature controls. In this embodiment the fiber optic panels are used as an alternative diffuser light medium that is situated between each stacked solar panel. The fiber optic cables terminates in a connector member 105 that is electrically connected to the solar panel.

A closed unit can also be filled with short half life radioactive liquids or gases, such as Tritium isotope (H3), and luminescent liquids to provide wave energy to energize solar cells.

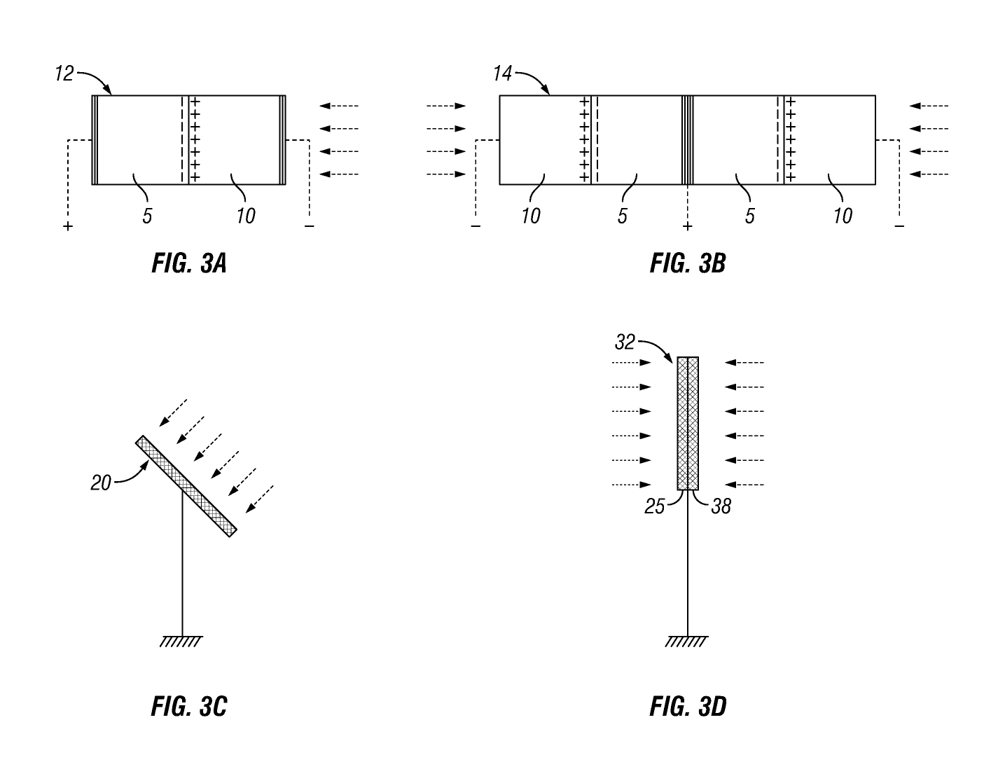

The current industrial solar panels in FIG. 1-6, are normally manufactured one-sided and only one side can see sunlight. FIGS. 3A and B illustrate the configuration of the normal solar panels, the solar cells are PN (5,10) type semiconductor chips. However, alternatively with this invention the solar panels can be manufactured two-sided since the both sides can be illuminated by using an external light source and/or sunlight using mirrors, acrylic and fiber optic panel arrangements as shown in FIGS. 3b and 3d). This can be done by NPPN (FIG. 3b) or NPN (not shown) type semiconductor chip configuration to increase power output and space efficiency on solar panel basis, as shown in FIGS. 3a and 3b.

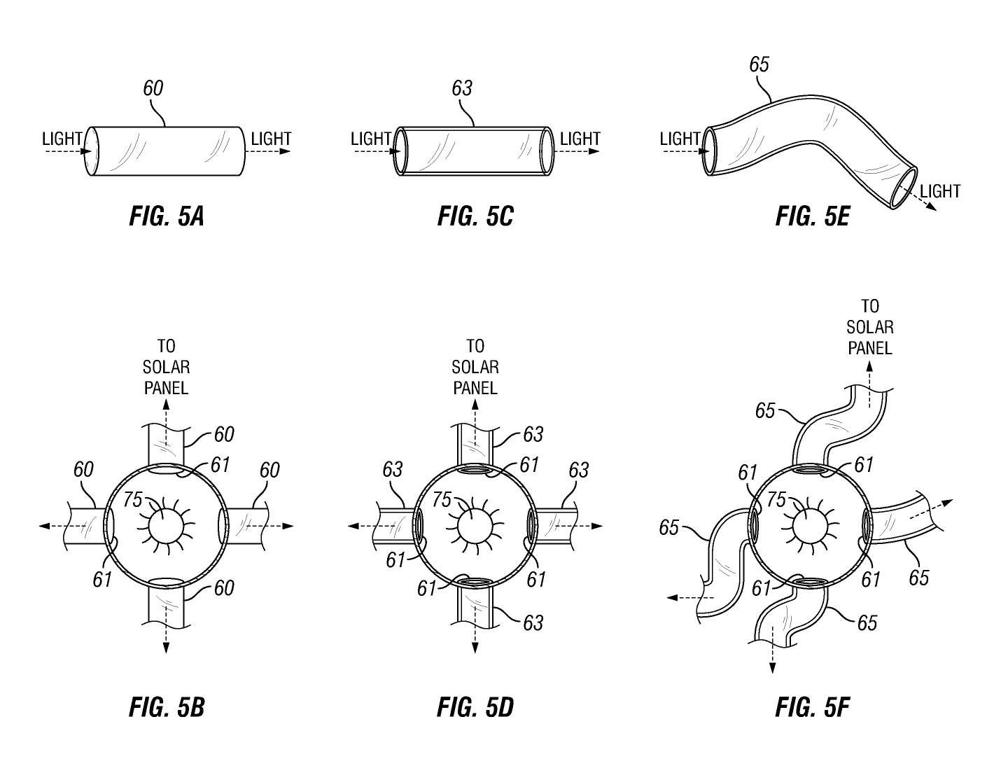

Referring to FIGS. 5a-5d, a single powerful light source, such as focused sunlight, LED light etc., can be distribute light energize solar panels by using acrylic rods, clear glass and plastic tubular mirrors as well as fiber optic cables as shown in FIG. 5. A light source is located in the center of a sphere and numerous rods, mirror tubes and fiber optic cables are installed on the sphere to transfer light to solar light panels. Tubular clear glass or any type plastic tube can be coated using chemicals to make internal mirror. This type of tubular mirrors and acrylic rods can be used in residential and commercial building lighting to distribute a single light source to various rooms to save energy.

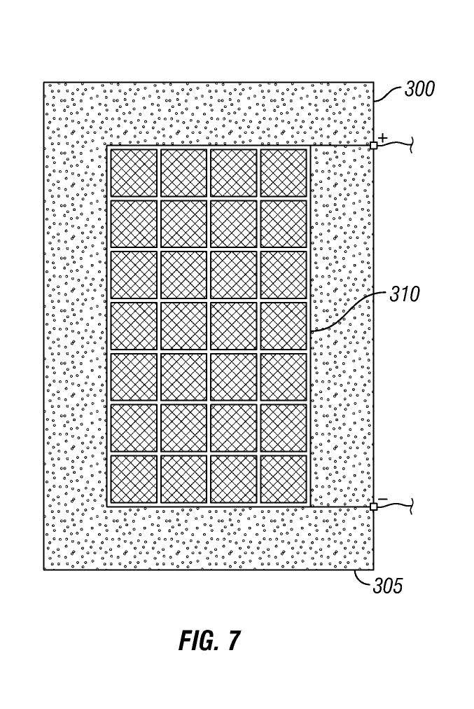

Referring to FIG. 7, a plurality of stacked solar panels with interior surface inwardly facing and are disposed in a radioactive container that energizes the solar cells mounted on the solar panels to generate electricity.

What is claimed is:

1. A solar system for generating electricity, the system comprising:
a plurality of spaced apart solar panels aligned in a stack parallel arrangement;
each solar panel having a flat interior surface area facing inwardly;
a plurality of solar cells electrically mounted onto the flat interior surface area; and
a light transfer diffuser medium situated between the flat interior surface area of opposing solar panels wherein the light is diffused onto the solar cells of solar panels thereby energizing the solar cells to generate electricity.

2. The system of claim 1 wherein the light transfer diffuser medium is a LED display screen panel.

3. The system of claim 1 wherein the solar cells generates DC current electricity that is electrically transmitted to an inverter to generate AC current to a power grid system supporting a designated area.

4. The system of claim 3 wherein the number of panels is predetermined by the amount of electricity required to effectively and sufficiently support the designated area.

5. The system of claim 1 wherein the light transfer diffuser medium is a LCD display screen panel.

6. The system of claim 1 wherein the light transfer diffuser medium is a plasma display screen panel.

7. The system of claim 1 wherein the light transfer diffuser medium further comprises an acrylic panel.

8. The system of claim 1 wherein the light transfer diffuser medium further comprises reflective material panel.

9. The system of claim 5 wherein a plurality of LEDs is vertically and electrically mounted to opposing peripheral side edges of the acrylic panel.

10. The system of claim 1 wherein the light transfer diffuser medium has a rectangular shape.

11. The system of claim 9 wherein the reflective material panel is glass.

12. The system of claim 9 wherein the reflective material panel is mirrors.

13. The system of claim 1 wherein the
